(19) United States
(12) Patent Application Publication
(10) Pub. No.: US 2024/0309132 A1
(43) Pub. Date: Sep. 19, 2024

(54) PROCESS OF MAKING CATALYTICALLY-ACTIVE PREPOLYMER COMPOSITION AND COMPOSITIONS MADE THEREBY

(71) Applicant: Dow Global Technologies LLC, Midland, MI (US)

(72) Inventors: Kishori Deshpande, Pearland, TX (US); Lalit A. Darunte, Sunnyvale, CA (US); Eduardo Garcia, Katy, TX (US)

(21) Appl. No.: 18/569,661

(22) PCT Filed: Sep. 19, 2022
(86) PCT No.: PCT/US2022/043943

§ 371 Date: Dec. 13, 2023

Related U.S. Application Data
(60) Provisional application No. 63/246,073, filed on Sep. 20, 2021.

(51) Int. Cl. C08F 10/02

(52) U.S. Cl. CPC C08F 10/02

(57) ABSTRACT

A process of making a catalytically-active prepolymer composition in a slurry-phase prepolymerization reaction, the catalytically-active prepolymer composition made thereby, and a process of making a polyolefin polymer using the catalytically-active prepolymer composition in a gas-phase polymerization reaction.

This application relates to the field of polyolefin prepolymers, polymers and processes to make them.

### INTRODUCTION

It is known to polymerize olefin monomers in the presence of a catalyst composition that initiates and catalyzes the polymerization reaction to make polyolefin polymers. Polymerization may take place in a liquid phase, in a slurry phase and/or in a gas phase with the catalyst composition suspended in a fluidized bed.

The catalyst composition is made by activating a procatalyst, which contains a catalytic metal such as magnesium, titanium, zirconium or hafnium, with an activator.

A class of procatalysts (“biphenylphenol procatalysts”) contains zirconium or hafnium complexed with a bulky polydentate ligand that comprises two biphenylphenol moieties bridged by an organic moiety (L). The biphenylphenol procatalysts meet the following Formula I:

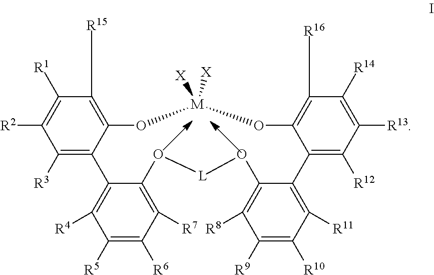

The biphenylphenol procatalysts and processes to make them are described in PCT Publication 2007/058981 A1 (15 Apr. 2017). It is desirable to develop optimized processes to polymerize olefins using these new procatalysts.

### SUMMARY

We have discovered that ordinary gas-phase fluidized bed polymerization is impractical using biphenylphenol catalysts. The biphenylphenol catalysts have high activity when introduced into the gas-phase fluidized bed reactor. Under ordinary conditions, the polymerization reaction runs so fast and the resulting exotherm gets so high that the polymer in the fluidized bed softens and agglomerates forming chunks and sheets that clog the reactor.

Our method to avoid this problem is to form a catalytically-active prepolymer composition in a slurry prepolymerization reaction by prepolymerizing under suitable conditions a small amount (compared to full polymerizations making final polymer products) of one or more olefin monomers with an activated catalyst composition that contains a biphenylphenol catalyst. The catalytically-active prepolymer composition made thereby can be used to catalyze a gas-phase fluidized bed polymerization. The slurry phase prepolymerization for making the catalytically-active prepolymer composition can be performed under suitable conditions that moderate the initial light-off of the catalyst and provide a high level of diluent to moderate the exotherm that occurs at catalyst light-off. The suitable conditions for the prepolymerization reaction are described later and are selected such that the resulting catalytically-active prepolymer composition remains capable of initiating and catalyzing substantial further polymerization of the one or more olefin monomers. The catalytically-active prepolymer composition has a smoother activation when introduced into the gas-phase fluidized bed polymerization.

In this description, “prepolymerization” means a polymerization that makes an intermediate polymer product, which is not the complete intended final polymer product. Likewise, a “prepolymer” is an intermediate polymer product that is not intended to be the final polymer product. “Prepolymerization” reactions in this invention are the same reaction by the same mechanism as an ordinary polymerization and make a similar product, but the reaction conditions may be selected to limit the yield of prepolymer to lower yield than would ordinarily be produced in an ordinary polymerization. In prepolymer compositions, the weight ratio of prepolymer to catalyst remnant is lower than the intended weight ratio of (co)polymer to catalyst remnant in the final intended polymer product. Further, in catalytically-active prepolymer compositions, the prepolymer is mixed with active remnants of the catalyst composition used to make the prepolymer. Prepolymers are not necessarily lower molecular-weight than the intended final polymer product. The prepolymers in the catalytically-active prepolymer composition of the present invention may or may not build further molecular weight when the catalytically-active prepolymer composition is used to catalyze a final polymerization reaction. For clarity, the term “prepolymer” may refer to both a homopolymer and a copolymer.

One aspect of the invention is a process for making a catalytically-active prepolymer composition in a slurry-phase prepolymerization reaction, comprising contacting:
(a) a catalyst composition comprising a biphenylphenol catalyst made by contacting a biphenylphenol procatalyst and an activator; and
(b) one or more olefin monomers,
   in a diluent under suitable conditions to prepolymerize the one or more olefin monomers with a yield of 5 parts to 600 parts of catalytically-active prepolymer composition per 1 part of the catalyst composition by weight, wherein the biphenylphenol procatalyst is of Formula I:

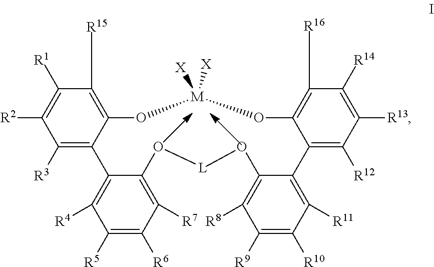

wherein each of R⁷ and R⁸ is independently a C₁ to C₂₀ alkyl, aryl or aralkyl, halogen, or a hydrogen;
wherein each of R⁴ and R¹¹ is independently a hydrogen, alkyl or a halogen;
wherein each of R⁵ and R¹⁰ is independently a C₁ to C₂₀ alkyl, aryl, aralkyl, halogen, an alkyl- or aryl-substituted silyl, or a hydrogen;
wherein each of R² and R¹³ is independently a C₁ to C₂₀ alkyl, aryl or aralkyl or a hydrogen;
wherein each of R¹⁵ and R¹⁶ is independently a 2,7-disubstituted carbazol-9-yl;
wherein each of R¹, R³, R⁶, R⁹, R¹², and R¹⁴ is independently a hydrogen or alkyl;
wherein L is a saturated C₂-C₃ alkylene that forms a 2-carbon bridge or 3-carbon bridge between the two oxygen atoms to which L is bonded;
wherein each X is independently halogen, a hydrogen, a (C₁-C₂₀)alkyl, a (C₇-C₂₀)aralkyl, a (C₁-C₆)alkyl-substituted (C₆-C₁₂)aryl, or a (C₁-C₆)alkyl-substituted benzyl, —CH₂Si(R^{C})₃, where R^{C} is C₁-C₁₂ hydrocarbon; and wherein M is zirconium or hafnium.

A second aspect of the present invention is a process to make a polyolefin (co)polymer, comprising the steps of:
(a) making a catalytically-active prepolymer composition in a slurry-phase prepolymerization reaction as previously described or as described in any one of Embodiments 2 to 9 disclosed later; and
(b) using the catalytically-active prepolymer composition to catalyze polymerization of further one or more olefin monomers under conditions to make the polyolefin (co)polymer. (Mole percentages are based on the total quantity of the one or more olefin monomers.) In some embodiments the further one or more olefin monomers contain from 80 to 100 mole percent ethylene or propylene and 0 to 20 mole percent of an α-olefin comonomer or a butadiene and the polymerization makes a polyethylene (co)polymer or a polypropylene (co)polymer, respectively.

A third aspect of the present invention is a catalytically-active prepolymer composition made by the process of the first aspect. In some embodiments the catalytically-active prepolymer composition comprises:
(1) an olefin prepolymer component consisting essentially of one or more olefin prepolymers and
(2) a residual catalyst component consisting essentially of remnants of the catalyst composition left over after the prepolymerization reaction; and wherein: (a) the olefin prepolymer component that has a number average molecular weight (Mₙ) between 5000 g/mol and 50,000 g/mol; and (b) the weight ratio of the olefin prepolymer component to the residual catalyst component is from 5:1 to 600:1.

The catalytically-active prepolymer composition can be used to catalyze polymerization of one or more olefin monomers, such as in a gas-phase fluidized bed polymerization. The resulting polymerization can proceed smoothly to completion without excessive exotherm or the agglomeration that an exotherm can cause.

Without intending to be bound, we hypothesize that the slurry-phase prepolymerization allows a controlled growth of the prepolymer with better heat transfer. Then, the prepolymer component in the catalytically-active prepolymer composition supplies higher surface area to dissipate the heat and lower activity at initiation in the final polymerization reaction.

### BRIEF DESCRIPTION OF THE DRAWING(S)

FIG. 1 shows the temperature profile for a gas-phase polymerization using the catalytically-active prepolymer composition of this invention, as compared with a gas-phase polymerization of ordinary spray-dried biphenylphenol catalyst composition.

### DETAILED DESCRIPTION

A process of making a catalytically-active prepolymer composition in a slurry-phase prepolymerization reaction, the catalytically-active prepolymer composition made thereby, and a process of making a polyolefin polymer using the catalytically-active prepolymer composition in a gas-phase polymerization reaction

### Activated Catalyst Compositions

The process of the present invention uses an activated catalyst composition that is formed by contacting a biphenylphenol procatalyst of Formula I above with an activator. Without intending to be bound, it is theorized that the activator reacts with the biphenylphenol procatalyst, such as by displacing one or more of the X moieties in the biphenylphenol procatalyst, when the two are contacted with each other.

Each of R⁷ and R⁸ as shown in Formula I, independently is a C₁ to C₂₀ alkyl, aryl or aralkyl, halogen, or a hydrogen. One or more embodiments provide that each of R⁷ and R⁸ is a C₁ alkyl.

An “alkyl” includes linear, branched and cyclic paraffin radicals that are deficient by one hydrogen. Thus, for example, a CH₃ group (“methyl”) and a CH₃CH₂ group (“ethyl”) are examples of alkyls.

“Aryl” includes phenyl, naphthyl, pyridyl and other radicals whose molecules have the ring structure characteristic of benzene, naphthalene, phenanthrene, anthracene, etc. An “aryl” can be a C₆ to C₂₀ aryl. For example, a C₆H₅— aromatic structure is a “phenyl”, a C₆H₄— aromatic structure is a “phenylene”.

An “aralkyl”, which can also be called an “arylalkyl, is an alkyl having an aryl pendant therefrom. An “aralkyl” can be a C₇ to C₂₀ aralkyl. An “alkylaryl” is an aryl having one or more alkyls pendant therefrom.

Examples of halogens include fluorine, chlorine or bromine. In some embodiments, the halogen may be chlorine. The halogen is typically in the form of a halide.

Each of R⁵ and R¹⁰ as shown in Formula I, independently is a C₁ to C₂₀ alkyl, aryl, aralkyl, halogen, an alkyl- or aryl-substituted silyl, or a hydrogen. For instance, one or more embodiments provide that R⁵ and R¹⁰ is a di-alkyl or tri-alkyl substituted silyl. One or more embodiments provide that each of R⁵ and R¹⁰ is an octyl dimethyl silyl.

Each of R⁴ and R¹¹ as shown in Formula I, independently is a hydrogen, alkyl or a halogen. For instance, one or more embodiments provide that each of R⁴ and R¹¹ is a hydrogen.

Each of R² and R¹³ as shown in Formula I, independently is a C₁ to C₂₀ alkyl, aryl or aralkyl or a hydrogen. One or more embodiments provide that each of R² and R¹³ is a C₃-C₄ alkyl such as n-butyl, t-butyl, or 2-methyl-pentyl. One or more embodiments provide that each of R² and R¹³ is a 1,1,3,3-tetramethylbutyl.

Each of R¹⁵ and R¹⁶ as shown in Formula I, is a 2,7-disubstituted carbazol-9-yl. For instance, one or more embodiments provide that each of R¹⁵ and R¹⁶ is a 2,7-disubstituted carbazol-9-yl selected from a group consisting of a 2,7-di-t-butylcarbazol-9-yl, a 2,7-diethylcarbazol-9-yl, a 2,7-dimethylcarbazol-9-yl, and a 2,7-bis(diisopropyl(n-octyl)silyl)-carbazol-9-yl.

Each of R¹, R³, R⁶, R⁹, R¹², and R¹⁴ is independently a hydrogen or alkyl. For instance, one or more embodiments provide that each of R¹, R³, R⁶, R⁹, R¹², and R¹⁴ is a hydrogen; and

L, as shown in Formula I, is a saturated C₂-C₃ alkyl that forms a 2-carbon or 3-carbon bridge between the two oxygen atoms to which L is bonded. For instance, one or more embodiments provide that L is a saturated C₃ alkylene that forms a bridge between the two oxygen atoms to which L is bonded. The term “saturated” means lacking carbon-carbon double bonds, carbon-carbon triple bonds, and (in heteroatom-containing groups) carbon-nitrogen, carbon-phosphorous, and carbon-silicon double or triple bonds.

Each X, as shown in Formula I, independently is a halogen, a hydrogen, a (C₁-C₂₀)alkyl, a (C₇-C₂₀)aralkyl, a (C₁-C₆)alkyl-substituted (C₆-C₁₂)aryl, or a (C₁-C₆)alkyl-substituted benzyl, —CH₂Si(R′)₃, where R¹ is C₁-C₁₂ hydrocarbon. For instance, one or more embodiments provide that each X is a C₁ alkyl.

M, as shown in Formula I, is a catalytic metal atom. In some embodiments, M is selected from a group consisting of Zr and Hf. One or more embodiments provide that M is zirconium. One or more embodiments provide that M is hafnium.

Each of the R groups (R¹-R¹⁶) and the X groups of Formula I, as described herein, can independently be substituted or unsubstituted. For instance, in some embodiments, each of the X groups of Formula I independently is a (C₁-C₆)alkyl-substituted (C₆-C₁₂)aryl, or a (C₁-C₆)alkyl-substituted benzyl. As used herein, “substituted” indicates that the group following that term possesses at least one moiety in place of one or more hydrogens in any position, the moieties selected from such groups as halogen radicals, hydroxyl groups, carbonyl groups, carboxyl groups, amine groups, phosphine groups, alkoxy groups, phenyl groups, naphthyl groups, C₁ to C₂₀ alkyl groups, C₂ to C₁₀ alkenyl groups, and combinations thereof. Being “disubstituted” refers to the presence of two or more substituent groups in any position, the moieties selected from such groups as halogen radicals, hydroxyl groups, carbonyl groups, carboxyl groups, amine groups, phosphine groups, alkoxy groups, phenyl groups, naphthyl groups, C₁ to C₂₀ alkyl groups, C₂ to C₁₀ alkenyl groups, and combinations thereof.

An exemplary biphenylphenol procatalyst meets the Formula 2:

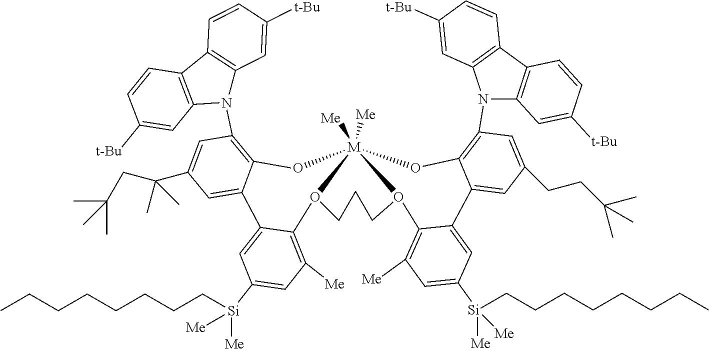

wherein M is a zirconium ion or a hafnium ion, t-Bu refers to a tertiary butyl group, t-Oct refers to a tertiary octyl group, n-Oct refers to a linear octyl group, and Me refers to a methyl group.

The catalyst compositions used in the present invention may optionally further contain another procatalyst, such as metallocene catalyst. Metallocene polymerization catalysts and processes to make them are well known and described in numerous references such as U.S. Pat. Nos. 5,772,669 and 8,497,330 B2; US Patent Publication 2006/0293470 A1; and in 1 & 2 Metallocene-Based Polyolefins (John Scheirs & W. Kaminsky eds., John Wiley & Sons, Ltd. 2000) and G. G. Hlatky in 181 Coordination Chem. Rev. 243-296 (1999). In many embodiments, the biphenylphenol procatalyst is essentially the only procatalyst used in the prepolymerization step.

The activated catalyst compositions used in the present invention are made by contacting the biphenylphenol procatalyst with an activator. As used herein, “activator” refers to any compound or combination of compounds, supported, or unsupported, which can activate a complex or a procatalyst component, such as by creating a cationic species of the procatalyst component. For example, this can include the abstraction of at least one leaving group, e.g., the “X” group described herein, from the metal center of the complex/catalyst component, e.g., the metal complex of Formula I. As used herein, “leaving group” refers to one or more chemical moieties bound to a metal atom and that can be abstracted by an activator, thus producing a species active towards olefin polymerization.

Some examples of the activator can include a Lewis acid or a non-coordinating ionic activator or ionizing activator, or Lewis bases, aluminum alkyls, and/or conventional-type co-catalysts. In addition to methylaluminoxane (“MAO”) and modified methylaluminoxane (“MMAO”), illustrative activators can include, but are not limited to, aluminoxane or modified aluminoxane, and/or ionizing compounds, neutral or ionic, such as Dimethylanilinium tetrakis(pentafluorophenyl)borate, Triphenylcarbenium tetrakis(pentafluorophenyl)borate, Dimethylanilinium tetrakis(3,5-(CF₃)₂phenyl)borate, Triphenylcarbenium tetrakis(3,5-(CF₃)₂phenyl)borate, Dimethylanilinium tetrakis(perfluoronapthyl)borate, Triphenylcarbenium tetrakis(perfluoronapthyl)borate, Dimethylanilinium tetrakis(pentafluorophenyl)aluminate, Triphenylcarbenium tetrakis(pentafluorophenyl)aluminate, Dimethylanilinium tetrakis(perfluoronapthyl)aluminate, Triphenylcarbenium tetrakis(perfluoronapthyl)aluminate, a tris(perfluorophenyl)boron, a tris(perfluoronaphthyl)boron, tris(perfluorophenyl)aluminum, a tris(perfluoronaphthyl)aluminum or any combinations thereof.

Aluminoxanes are described as oligomeric aluminum compounds having —Al(R)—O— subunits, where R is an alkyl group. Examples of aluminoxanes include, but are not limited to, methylaluminoxane (“MAO”), modified methylaluminoxane (“MMAO”), ethylaluminoxane, isobutylaluminoxane, or a combination thereof. Aluminoxanes can be produced by the hydrolysis of the respective trialkylaluminum compound. MMAO can be produced by the hydrolysis of trimethylaluminum and a higher trialkylaluminum, such as triisobutylaluminum. There are a variety of known methods for preparing aluminoxane and modified aluminoxanes. The aluminoxane can include a modified methyl aluminoxane (“MMAO”) type 3A (commercially available from Akzo Chemicals, Inc. under the trade name Modified Methylaluminoxane type 3A, discussed in U.S. Pat. No. 5,041,584). A source of MAO can be a solution having from 1 wt. % to 50 wt. % MAO, for example. Commercially available MAO solutions can include the 10 wt. % and 30 wt. % MAO solutions available from Albemarle Corporation, of Baton Rouge, La.

One or more organo-aluminum compounds, such as one or more alkylaluminum compound, can be used in conjunction with the aluminoxanes. Examples of alkylaluminum compounds include, but are not limited to, diethylaluminum ethoxide, diethylaluminum chloride, diisobutylaluminum hydride, and combinations thereof. Examples of other alkylaluminum compounds, e.g., trialkylaluminum compounds include, but are not limited to, trimethylaluminum, triethylaluminum (“TEAL”), triisobutylaluminum (“TiBAl”), tri-n-hexylaluminum, tri-n-octylaluminum, tripropylaluminum, tributylaluminum, and combinations thereof.

In some embodiments of the activated catalytic composition, the molar ratio of metal in the activator to metal in the biphenylphenol procatalyst may be at least 0.5:1 or at least 1:1. In some embodiments, the molar ratio of metal in the activator to metal in the biphenylphenol procatalyst may be at most 1000:1 or at most 300:1 or at most 150:1.

Some embodiments of the activated catalytic compositions further comprise a carrier material. The carrier material may be a porous material, for example, talc, an inorganic oxide, or an inorganic chloride. Other carrier materials include resinous materials, e.g., polystyrene, functionalized or crosslinked organic carriers, such as polystyrene divinyl benzene polyolefins or polymeric compounds, zeolites, clays, or any other organic or inorganic carrier material and the like, or mixtures thereof.

Carrier materials include inorganic oxides that include Group 2, 3, 4, 5, 13 or 14 metal oxides. Some exemplary carrier materials include silica, fumed silica, alumina, silica-alumina, and mixtures thereof. Some other carrier materials include magnesia, titania, zirconia, magnesium chloride, montmorillonite, phyllosilicate, zeolites, talc, clays) and the like. Also, combinations of these carrier materials may be used, for example, silica-chromium, silica-alumina, silica-titania and the like. Additional carrier materials may include porous acrylic polymers, nanocomposites, aerogels, spherulites, and polymeric beads.

An example of a carrier material is fumed silica available under the trade name Cabosil™ TS-610, or other TS- or TG-series carriers, available from Cabot Corporation. Fumed silica is typically a silica with particles 7 to 30 nanometers in size that has been treated with dimethylsilyldichloride such that a majority of the surface hydroxyl groups are capped.

Exemplary carrier materials may have a surface area in the range of from 10 to 700 m²/g, pore volume in the range of from 0.1 to 4.0 g/cm³ and average particle size in the range of from 5 to 500 μm. Alternatively, the surface area of the carrier material is in the range of from 50 to 500 m²/g, pore volume of from 0.5 to 3.5 g/cm³ and average particle size of from 10 to 200 μm. Alternatively, the surface area of the carrier material is in the range is from 100 to 400 m²/g, pore volume from 0.8 to 3.0 g/cm³ and average particle size is from 5 to 100 μm. The average pore size of the carrier material typically has pore size in the range of from 10 to 1000 A, or from 50 to 500 A, or from 75 to 350 A.

In some embodiments of the activated catalyst composition, remnants of the biphenylphenol procatalyst and the activator are deposited on the carrier material. The biphenylphenol procatalyst and activator can be deposited on the carrier material by known methods, such as forming a slurry of biphenylphenol procatalyst, activator and carrier material and then drying or spray-drying. In this case the carrier material forms the core of an activated catalyst granule, and the remnant of biphenylphenol procatalyst and activator forms a shell on the carrier material core.

### Prepolymerization

In the present invention, a slurry phase prepolymerization reaction is carried out by contacting the activated catalyst composition described above with one or more olefin monomers in a diluent under conditions suitable to polymerize the one or more olefin monomers. The slurry-phase prepolymerization reaction makes a catalytically-active prepolymer composition. Prepolymerization reactions of olefin monomers have been reported, such as in the following references: EP 1138699 A1; U.S. Pat. No. 5,326,835; WO96/18662 A1; WO99/48929 A1; WO00/21656 A1; WO03/037941 A1; WO10/034664 A1; WO17/021122 A1 and 20/064568 A1.

The prepolymerization uses the one or more olefin monomers. As used herein an olefin monomer is a linear, branched, or cyclic compound comprising carbon and hydrogen and having at least one double bond in position suitable for polymerization. Examples of suitable olefin monomers are linear or branched hydrocarbons having from 2 to 12 carbon atoms (or 2 to 10 carbon atoms or 2 to 8 carbon atoms) and having a single double bond in an alpha position. Particular examples of the one or more olefin monomers include ethylene, propylene, 1-butene, 1-pentene, 1-hexene, 4-methyl-1-pentene, 1-heptene and 1-octene. In some embodiments the prepolymerization uses only one olefin monomer, e.g., ethylene or propylene, alternatively ethylene. In other embodiments the prepolymerization uses two olefin monomers, e.g., ethylene and propylene or ethylene and an alpha-olefin containing from 4 to 8 carbon atoms, alternatively ethylene and an alpha-olefin containing from 4 to 8 carbon atoms, alternatively ethylene and 1-butene, alternatively ethylene and 1-hexene, alternatively ethylene and 1-octene.

In some embodiments, the one or more olefin monomers contain 50 to 100 mole percent ethylene and 0 to 50 mole percent of an α-olefin comonomer. (Mole percentages are based on the total quantity of the one or more olefin monomers) As used herein an α-olefin comonomer refers to a linear, branched, or cyclic compound comprising carbon and hydrogen and having at least one double bond in an alpha position. The α-olefin comonomers typically have from 3 to 12 carbon atoms. In certain examples, the α-olefin comonomer has at least 4 carbon atoms. In certain examples, the α-olefin comonomer has at most 10 carbon atoms or at most 8 carbon atoms. Exemplary alpha-olefin comonomers include, but are not limited to, propylene, 1-butene, 1-pentene, 1-hexene, 1-heptene, 1-octene, and 4-methyl-1-pentene. In some embodiments, the alpha-olefin comonomers are selected from the group consisting of 1-butene, 1-hexene, and 1-octene, or from the group consisting of 1-butene and 1-hexene.

In some embodiments, the one or more olefin monomers contain at least 80 mole percent ethylene or at least 85 mole percent ethylene or at least 90 mole percent ethylene or at least 92 mole percent ethylene, based on the total quantity of the one or more olefin monomers. In some embodiments, the one or more olefin monomers contain at least 99 mole percent ethylene, based on the total weight of the one or more olefin monomers. In other embodiments, the one or more olefin monomers contain at least 1 mole percent α-olefin comonomer or at least 2 mole percent α-olefin comonomer or at 4 mole percent α-olefin comonomer or at least 6 mole percent α-olefin comonomer, based on the total quantity of the one or more olefin monomers.

The prepolymerization reaction takes place in a diluent that is a liquid and is stable and non-reactive under the conditions of the prepolymerization. The diluent is capable is dissolving the one or more olefin monomers under the reaction conditions. However, the activated catalyst composition and the resulting catalytically-active prepolymer composition are substantially insoluble in the diluent under the polymerization conditions and form a slurry in the diluent. For this reason, the prepolymerization reaction is said the be a slurry-phase polymerization.

Examples of suitable diluents for the slurry phase prepolymerization reaction include mineral oil and alkanes having from 3 to 12 carbon atoms or from 3 to 10 carbon atoms or from 4 to 10 carbon atoms or from 3 to 8 carbon atoms, such as propane, butane, isobutane, pentane, isopentane, hexane, methylhexane, cyclohexane or heptane.

In some embodiments, the weight ratio of diluent to total olefin monomers is at least 5:1 or at least 10:1 or at least 12:1 or at least 15:1. In some embodiments, the weight ratio of diluent to total olefin monomers is at most 800:1 or at most 700:1 or at most 600:1.

In some embodiments it may be convenient to select a diluent for the prepolymerization reaction that is also useful as a diluent in the subsequent polymerization reaction for the catalytically-active prepolymer composition. In this way, it is not necessary to fully remove the prepolymerization diluent before using the catalytically-active prepolymer composition to catalyze further polymerization.

The prepolymerization reaction takes place in a prepolymerization reactor. The prepolymerization reactor may be any reactor known for slurry phase polymerization, such as a stirred tank reactor, a tubular reactor, an autoclave or a loop reactor. In particular embodiments, the prepolymerization reactor is a loop reactor or a stirred tank reactor. The prepolymerization reaction may take place in a batch process or a continuous process.

The suitable conditions for the prepolymerization reaction are selected such that the resulting catalytically-active prepolymer composition remains capable of initiating and catalyzing substantial further polymerization of the one or more olefin monomers. The suitable conditions may comprise using a reaction temperature described below that is lower than temperatures used in gas-phase fluidized bed polymerizations, using a pressure described below, using the diluent to limit the exothermic rise in temperature during prepolymerization, and using a relatively small amount (compared to gas-phase fluidized bed polymerizations making final polymer products) of the one or more olefin monomers so as to yield of 5 parts to 600 parts of catalytically-active prepolymer composition per 1 part of the catalyst composition by weight.

For example, in some embodiments the temperature of the prepolymerization reaction (which is usually measured as the internal temperature in the prepolymerization reactor) may be at least 10° C. or at least 20° C. or at least 25° C. or at least 30° C. or at least 35° C. or at least 40° C. In some embodiments the temperature the prepolymerization reaction may be at most 90° C. or at most 80° C. or at most 75° C. or at most 70° C. In some embodiments, the pressure of the prepolymerization reaction is at least 50 psi or at least 75 psi or at least 100 psi or at least 120 psi. In some embodiments, the pressure of the prepolymerization reaction is at most 180 psi or at most 150 psi or at most 130 psi.

In many embodiments, the suitable conditions for the prepolymerization reaction are milder than the conditions later used for final polymerization. For example, the temperature of the prepolymerization reaction may be at least 5° C. lower than the temperature of the final polymerization, or at least 10° C. lower, or at least 20° C. lower, or at least 30° C. lower, or at least 40° C. lower or at least 50° C. lower.

In some embodiments, the pressure for the prepolymerization reaction may be higher than the pressure later used for final polymerization, so that the catalytically-active prepolymer composition flows easily from the prepolymerization step into the polymerization step. For example, the pressure in the prepolymerization step may be at least 1 psi higher than the pressure in the polymerization step, or at least 2 psi higher, or at least 3 psi higher or at least 5 psi higher.

The prepolymerization reaction may be carried out in the presence of other known reagents, such as hydrogen and/or chain transfer agents to assist in controlling polymer chain growth.

The prepolymerization reaction is carried out under suitable conditions such that the yield of catalytically-active prepolymer composition (measured as weight parts of catalytically-active prepolymer composition excluding residual diluent per weight part of activated catalyst composition) is at most 600:1. In some embodiments, the yield may be at most 500:1 or at most 400:1 or at most 300:1 or at most 200:1 or at most 100:1 or at most 50:1. In some embodiments, the yield of catalytically-active prepolymer composition from the prepolymerization reaction (measured as weight parts of catalytically-active prepolymer composition per weight part of activated catalyst composition) is at least 5:1. In some embodiments, the yield may be at least 10:1. Prepolymerization reactions are characterized by having a relatively low yield of prepolymer to activated catalyst composition, as compared to ordinary polymerization reactions. We hypothesize that in most cases the yield of catalytically-active prepolymer composition corresponds roughly to the ratio of prepolymer component to residual catalyst component in the catalytically-active prepolymer composition.

Methods are known to control the yield of prepolymer, and thus control the ratio of prepolymer component to residual catalyst component in the catalytically-active prepolymer composition. One method is to limit the total quantity of the one or more olefin monomers that are dissolved in the diluent and are available for reaction in the slurry-phase prepolymerization reaction. Slurry polymerization occurs by reaction of activated catalyst composition that is slurried in the diluent with olefin monomers that are dissolved in the diluent. Prepolymerization normally happens very quickly. If the total quantity of the one or more olefin monomers dissolved in the diluent is low, and the catalytically-active prepolymer composition is recovered before substantial more olefin monomers enter the diluent, the yield of catalytically-active prepolymer composition and the ratio of prepolymer component to residual catalyst component in the catalytically-active prepolymer composition can be limited.

The selection of mild prepolymerization conditions plus the diluent used in the prepolymerization can make it possible to control the temperature rise in the prepolymerization reactor during prepolymerization. The temperature rise in the prepolymerization reaction arising from catalyst initiation can be limited to no more than 20° C. or no more than 15° C. or no more than 10° C. or no more than 5° C.

In some embodiments, the resulting catalytically-active prepolymer composition is recovered from the diluent, such as by sieving, centrifuge′ evaporation, extraction or washing. In some particular embodiments, diluent may be removed by evaporation under increased temperature and/or reduced pressure. In other embodiments, the diluent is compatible with the further polymerization using the catalytically-active prepolymer composition, and no removal of diluent is necessary.

In some embodiments, the catalytically-active prepolymer composition is fed directly into the polymerization step after it is recovered from the prepolymerization step. In other embodiments, the catalytically-active prepolymer composition is recovered, passivated and stored before being fed into the polymerization step. To passivate the catalyst, it is recovered under inert atmosphere and flushed of reactive materials, such as monomers and hydrogen. The inert atmosphere may comprise, for example, nitrogen or noble gases, and is frequently nitrogen. To flush reactive materials, the catalytically-active prepolymer composition is placed under a raised pressure of inert atmosphere and then the atmosphere is released back down to near ambient atmosphere one or more times. This flushing with inert atmosphere is optionally carried out more than once. In connection with flushing, the inert atmosphere may be used to move the catalytically-active prepolymer composition from the prepolymerization reactor into the product storage container. The catalytically-active prepolymer composition is stored under inert conditions until it is fed into the polymerization reactor. Unlike the products of a full polymerization, the catalytically-active prepolymer composition should not be contacted with a compound that deactivates remnants of the catalyst in the composition.

### Catalytically-Active Prepolymer Compositions

The prepolymerization reaction makes a catalytically-active prepolymer composition that comprises the reaction products of the activated catalyst composition and the one or more olefin monomers, which reaction products include: (1) a prepolymer component; and (2) a residual catalyst component.

The residual catalyst component that should be capable of initiating and catalyzing further polymerization of the one or more olefin monomers. The residual catalyst component contains or consists essentially of the remnants of the activated catalyst composition that was used in the prepolymerization reaction.

The prepolymer component contains or consists essentially of polyolefin polymers having repeating units based on the one or more olefin monomers used in the prepolymerization reaction. Embodiments of the one or more olefin monomers and their ratios are described above. In some embodiments, the number average molecular weight (Mₙ) of the prepolymer component is at most 60,000 g/mol or at most 50,000 g/mol or at most 40,000 g/mol or at most 35,000 g/mol. In some embodiments, the number average molecular weight (Mₙ) of the prepolymer component is at least 5000 g/mol or at least 8000 g/mol or at least 10,000 g/mol.

The weight ratio of prepolymer component to the residual catalyst component is at least 5:1. In some embodiments, the weight ratio of prepolymer component to residual catalyst component may be at least 10:1. The weight ratio of prepolymer component to residual catalyst component is at most 600:1. In some embodiments, the weight ratio of prepolymer component to residual catalyst component may be at most 500:1 or at most 400:1 or at most 300:1 or at most 200:1 or at most 100:1 or at most 50:1.

The catalytically-active prepolymer composition may be dried so that it contains essentially no residual diluent. Alternatively, the catalytically-active prepolymer composition further may contain residual diluent if the residual diluent and its concentration are compatible with the intended use of the catalytically-active prepolymer composition. For example, gas-phase fluidized bed polymerization is sometimes carried out in the presence of pentane, isopentane, hexane or heptane diluent, and so residual pentane, isopentane, hexane or heptane diluent in the catalytically-active prepolymer composition may not interfere with the final polymerization reaction.

In some embodiments, the weight ratio of diluent to other components of the catalytically-active prepolymer composition is at least 5:1 or at least 10:1 or at least 12:1 or at least 15:1. In some embodiments, the weight ratio of diluent to other components of the catalytically-active prepolymer composition is at most 800:1 or at most 700:1 or at most 600:1.

### Polymerization Step

The catalytically-active prepolymer composition may be used to catalyze polyolefin polymerization reactions. In the polymerization reaction, the catalytically-active prepolymer composition is contacted with further olefin monomers under conditions such that the one or more olefin monomers are polymerized to form a polyolefin (co)polymer. (The term “(co)polymer” describes both homopolymers and copolymers.) The one or more olefin monomers and ratios of the one or more olefin monomers used in the final polymerization have the same description and embodiments previously given for the prepolymerization reaction.

The one or more olefin monomers used in the polymerization reaction may be the same as the one or more olefin monomers used in the prepolymerization reaction, or they may be different. If different olefin monomers are used in the polymerization reaction, then the resulting polyolefin (co)polymer product may comprise a blend of two or more polyolefin (co)polymers.

Likewise, the degree of polymerization in the polymerization reaction may be the same as the degree of polymerization in the prepolymerization reaction, or they may be different. If the polymerization reaction has a different degree of polymerization from the prepolymerization reaction, then the resulting polyolefin (co)polymer product may have a bimodal molecular-weight distribution.

The polymerization reaction may take place in a gas-phase, solution phase or slurry phase. The polymerization reaction may take place in a single polymerization reactor or in a plurality of staged polymerization reactors. Such reactions and reactors to perform them are well-known. In some embodiments, the polymerization reactor may be the same as the prepolymerization reactor, but more often the polymerization reactor is a different reactor from the prepolymerization reactor. The polymerization reaction optionally comprises a gas-phase reaction, such as a gas-phase fluidized bed polymerization.

In a gas-phase fluidized bed polymerization process, a continuous cycle may be employed, wherein in one part of the cycle of a reactor system, a cycling gas stream, otherwise known as a recycle stream or fluidizing medium, is heated in the reactor by the heat of polymerization. This heat may be removed from the cycling gas stream in another part of the cycle by a cooling system external to the reactor. Generally, in a gas-phase fluidized bed process for producing polyolefin (co)polymers, a gaseous stream containing one or more monomers may be continuously cycled through a fluidized bed in the presence of a catalyst under reactive conditions. The gaseous stream may be withdrawn from the fluidized bed and recycled back into the reactor. Simultaneously, polyolefin (co)polymer product may be withdrawn from the reactor, and fresh olefin monomer is added to replace the polymerized monomer. In some embodiments, a diluent is added to the gas-phase fluidized bed polymerization to help control reaction rate and temperature in the reactor. Diluents are generally inert under polymerization conditions. Common diluents include nitrogen and alkanes containing 4-10 carbon atoms. Gas phase polymerization process are described in more detail in, for example, U.S. Pat. Nos. 4,543,399, 4,588,790, 5,028,670, 5,317,036, 5,352,749, 5,405,922, 5,436,304, 5,453,471, 5,462,999, 5,616,661, and 5,668,228.

The reactor pressure in a gas phase process may vary, for example, from atmospheric pressure to 600 psig, or from 100 psig (690 kPa) to 500 psig (3448 kPa), or from 200 psig (1379 kPa) to 450 psig (2759 kPa), or from 250 psig (1724 kPa) to 450 psig (2414 kPa). The reactor temperature in a gas phase process may vary, for example, from 30° C. to 120° C., or from 60° C. to 115° C., or from 70° C. to 110° C., or from 70° C. to 100° C.

Additional examples of gas phase processes that may be used include those described in U.S. Pat. Nos. 5,627,242, 5,665,818 and 5,677,375, and European publications EP A-0 794 200, EP-A-0 802 202, EP-A2 0 891 990, and EP-B-634 421.

Embodiments of the polymerization reaction may include a slurry-phase polymerization process. In the slurry polymerization process, pressures may range from 1 to 50 atmospheres and temperatures may range from 0° C. to 120° C. In a slurry polymerization, a suspension of solid, particulate polymer may be formed in a liquid polymerization diluent medium to which ethylene and comonomers and often hydrogen along with catalyst are added. The suspension including diluent may be intermittently or continuously removed from the reactor where the volatile components are separated from the polymer and recycled, optionally after a distillation, to the reactor. The liquid diluent employed in the polymerization medium may typically be an alkane having from 3 to 7 carbon atoms, and in many embodiments is a branched alkane. The medium employed should be liquid under the conditions of polymerization and relatively inert. When a propane medium is used the process should be operated, for example, above the reaction diluent critical temperature and pressure. In some embodiments, a hexane or an isobutane medium is employed.

Embodiments of the polymerization reaction may include a solution polymerization process. In general, a solution phase polymerization process occurs in one or more well-stirred reactors such as one or more loop reactors or one or more spherical isothermal reactors at a temperature in the range of from 120° C. to 300° C.; for example, from 160° C. to 215° C., and at pressures in the range of from 300 psi to 1500 psi; for example, from 400 psi to 750 psi. The residence time in solution phase polymerization process is typically in the range of from 2 to 30 minutes (min); for example, from 10 to 20 min. Ethylene, one or more solvents, one or more catalyst systems, and optionally one or more comonomers are fed continuously to the one or more reactors. Exemplary solvents include, but are not limited to, isoparaffins. For example, such solvents are commercially available under the name Isopar E from ExxonMobil Chemical Co. The resultant mixture of the ethylene based polymer and solvent is then removed from the reactor and the ethylene based polymer is isolated. Solvent is typically recovered via a solvent recovery unit, i.e., heat exchangers and vapor liquid separator drum, and is then recycled back into the polymerization system. Examples of solution phase polymerization are described in Patent Application WO 2017/058981 A1.

Additional catalyst compositions may be added during the polymerization reaction, or the catalytically-active prepolymer composition may be the only catalyst composition used in the polymerization.

In some embodiments, the polymerization reaction may be performed in the presence of a diluent that is compatible with or the same as the diluent used in the prepolymerization reaction. In these embodiments, it may be unnecessary to fully remove the prepolymerization diluent before using the catalytically-active prepolymer composition in the polymerization reaction.

Catalytically-active prepolymer compositions of this invention may exhibit a smoother activation than the activated catalyst composition that they are derived from, as measured by internal reactor temperature in the polymerization reactor. Further, certain catalytically-active prepolymer compositions may produce lesser amounts of fine particles than the activated catalyst composition that they are made from.

A particular embodiment of the invention is a process to make a polyolefin (co)polymer comprising the steps of:
(a) providing an activated catalyst composition by depositing biphenylphenol procatalyst and aluminum-containing activator on a silicon-containing carrier material;
(b) performing a slurry-phase prepolymerization reaction by contacting the activated catalyst composition with olefin monomers that contain 80 to 100 mole percent ethylene and 0 to 20 mole percent of an α-olefin comonomer having 4 to 8 carbons in an alkane diluent having 3 to 12 carbon atoms, to form a catalytically-active prepolymer composition that contains both prepolymer component and residual catalyst component in a weight ratio from 5:1 and 600:1; and
(c) performing a gas-phase fluidized bed polymerization reaction by contacting the catalytically-active prepolymer composition with olefin monomers that contain 80 to 100 mole percent ethylene and 0 to 20 mole percent of an α-olefin comonomer having 4 to 8 carbons under conditions suitable to make a polyolefin (co)polymer.

Resulting polyolefin (co)polymers may have similar properties to polyolefin (co)polymers made by common processes. For example, for some common embodiments of ethylene (co)polymers:
The density of the (co)polymer may be at least 0.87 g/cm³ or at least 0.90 g cm³ or at least 0.91 g/cm³ and the density of the copolymer may be at most 0.99 g/cm³ or at most 0.98 g/cm³ or at most 0.97 g/cm³. For example, some low-density copolymers may have density from 0.91 g/cm³ to 0.96 g/cm³ or from 0.91 g/cm³ to 0.94 g/cm³, and some high-density (co)polymers may have density from 0.94 g/cm³ to 0.98 g/cm³.
The melt index (1_{2.1}) of the (co)polymer (as determined by ASTM D1238 at 190° C., 21 kg load) may be at least 0.5 g/10 min. or at least 1 g/10 min. or at least 2 g/10 min. The melt index (I_{2.1}) of the (co)polymer may be at most 50 g/10 min. or at most 35 g/10 min. or at most 25 g/10 min.
The weight average molecular weight (M_{w}) of the (co)polymer may be from 50,000 g/mol to 1,000,000 g/mol. All individual values and subranges from 50,000 g/mol to 1,000,000 g/mol are included; for example, the (co)polymer can have an overall M_{w} from a lower limit of 50,000 g/mol; 100,000 g/mol; or 200,000 g/mol; to an upper limit of 1,000,000 g/mol; 800,000 g/mol; or 600,000 g/mol. In some embodiments the overall M_{w} can be in a range from 218,937 g/mol to 529,748 g/mol.

The (co)polymer can be used for articles such as films, fibers, nonwoven and/or woven fabrics, extruded articles, and/or molded articles, among others.

### Numbered Embodiments

Several aspects of the present disclosure are illustrated by the following numbered embodiments.

1. A process for making a catalytically-active prepolymer composition in a slurry-phase prepolymerization reaction, comprising contacting:
(a) a catalyst composition comprising a biphenylphenol catalyst made by activating a biphenylphenol procatalyst with an activator; and
(b) one or more olefin monomers, in a diluent under suitable conditions to polymerize the one or more olefin monomers with a yield of 5 parts to 600 parts of the catalytically-active prepolymer composition per 1 part of the catalyst composition by weight;
   wherein the biphenylphenol procatalyst is of Formula I:

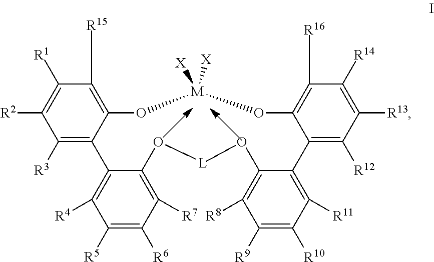

wherein each of R⁷ and R⁸ is independently a C₁ to C₂₀ alkyl, aryl or aralkyl, halogen, or a hydrogen;
wherein each of R⁴ and R¹¹ is independently a hydrogen, alkyl or a halogen; wherein each of R⁵ and R¹⁰ is independently a C₁ to C₂₀ alkyl, aryl, aralkyl, halogen, an alkyl- or aryl-substituted silyl, or a hydrogen;
wherein each of R² and R¹³ is independently a C₁ to C₂₀ alkyl, aryl or aralkyl or a hydrogen;
wherein each of R¹⁵ and R¹⁶ is independently a 2,7-disubstituted carbazol-9-yl; wherein each of R¹, R³, R⁶, R⁹, R¹², and R¹⁴ is independently a hydrogen or alkyl;
wherein L is a saturated C₂-C₃ alkylene that forms a 2-carbon bridge or 3-carbon bridge between the two oxygen atoms to which L is bonded;
wherein each X is independently halogen, a hydrogen, a (C₁-C₂₀)alkyl, a (C₇-C₂₀)aralkyl, a (C₁-C₆)alkyl-substituted (C₆-C₁₂)aryl, or a (C₁-C₆)alkyl-substituted benzyl, —CH₂Si(R^{C})₃, where R^{C} is C₁-C₁₂ hydrocarbon; and wherein M is zirconium or hafnium. The catalytically-active prepolymer composition is made by the contacting step.

2. The process as described in Embodiment 1 wherein the one or more olefin monomers comprise 80 to 100 mole percent ethylene monomer and 0 to 20 mole percent of an α-olefin comonomer that contains from 4 to 8 carbon atoms, based on total quantity of the one or more olefin monomers.

3. The process as described in any one of Embodiments 1 to 2 wherein the yield of the catalytically-active prepolymer composition is 5 parts to 400 parts of catalytically-active prepolymer composition per 1 part of the catalyst composition by weight.

4. The process as described in any one of Embodiments 1 to 3 wherein the yield of catalytically-active prepolymer composition is 5 parts to 200 parts of catalytically-active prepolymer composition per 1 part of the catalyst composition by weight.

5. The process as described in any one of Embodiments 1 to 4 wherein the diluent is an alkane that contains from 4 to 10 carbon atoms.

6. The process as described in any one of Embodiments 1 to 5 wherein the weight ratio of the diluent to total olefin monomers is from 5:1 to 800:1.

7. The process as described in any one of Embodiments 1 to 6 wherein the suitable conditions comprise a temperature of the slurry-phase prepolymerization reaction from 25° C. to 80° C.

8. The process as described in any one of Embodiments 1 to 7 wherein the biphenylphenol procatalyst meets the following formula:

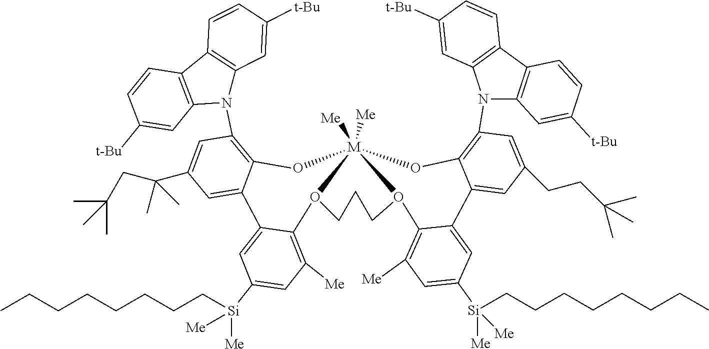

wherein M is a zirconium ion or a hafnium ion, t-Bu refers to a tertiary butyl group, t-Oct refers to a tertiary octyl group, n-Oct refers to a linear octyl group, and Me refers to a methyl group.

The process as described in any one of Embodiments 1 to 8, wherein the yield of 5 parts to 600 parts of the catalytically-active prepolymer composition per 1 part of the catalyst composition by weight is achieved by controlling the total amount of the one or more olefin monomers used in the contacting step.

10. A process to make a polyolefin (co)polymer comprising the steps of:
(a) making a catalytically-active prepolymer composition in a slurry-phase prepolymerization reaction as described in any one of Embodiments 1 to 9; and
(b) using the catalytically-active prepolymer composition to catalyze gas-phase polymerization of further one or more olefin monomers to make the polyolefin (co)polymer. In some embodiments that the further one or more olefin monomers contain from 80 to 100 mole percent ethylene or propylene and 0 to 20 mole percent of an α-olefin comonomer having 4 to 8 carbons or a butadiene to make a polyethylene (co)polymer or a polypropylene (co)polymer.

11. The process as described in Embodiment 10 wherein the temperature of the slurry-phase prepolymerization reaction is at least 5° C. lower than the temperature of the gas phase polymerization.

12. The process as described in any one of Embodiments 10 and 11 wherein the gas phase polymerization step takes place in the presence of a diluent that is the same as the diluent used in the slurry-phase prepolymerization reaction.

13. The process as described in any one of Embodiments 10 to 12 (i) wherein the catalytically-active prepolymer composition is fed directly from the slurry-phase prepolymerization step to the fluidized bed polymerization step without recovering and passivating the catalytically-active prepolymer composition; (ii) wherein the catalytically-active prepolymer composition is recovered after the slurry-phase prepolymerization step, passivated, and stored before being used in the gas-phase polymerization step; or both (i) and (ii).

14. The process as described in any one of Embodiments 10 to 13 which comprises the following steps:
(a) making the catalyst composition by depositing the biphenylphenol procatalyst and the activator on a silicon-containing carrier material, wherein the activator contains aluminum and contacts the biphenylphenol procatalyst;
(b) performing the slurry-phase prepolymerization reaction by contacting the catalyst composition with one or more olefin monomers that contain 80 to 100 mole percent ethylene and 0 to 20 mole percent of an α-olefin comonomer having 4 to 8 carbons in an alkane diluent having 3 to 12 carbon atoms, to form a catalytically-active prepolymer composition that contains both an olefin prepolymer component and a residual catalyst component in a weight ratio from 5:1 and 600:1, wherein the olefin prepolymer component consists essentially of one or more olefin prepolymers and wherein the residual catalyst component consists essentially of remnants of the catalyst composition; and (c) performing a gas-phase fluidized bed polymerization reaction by contacting the catalytically-active prepolymer composition with further one or more olefin monomers that contain 80 to 100 mole percent ethylene and 0 to 20 mole percent of an α-olefin comonomer having 4 to 8 carbons under conditions suitable to make a polyolefin (co)polymer. The catalyst composition is made by step (a).

15. A catalytically-active prepolymer composition made by the process as described in any one of Embodiments 1 to 9. In some embodiments the catalytically-active prepolymer composition comprises:
(1) a prepolymer component consisting essentially of one or more olefin prepolymers and
(2) a residual catalyst component consisting essentially of remnants of the catalyst composition left over after the prepolymerization reaction; and
wherein: (a) the olefin prepolymer component has a number average molecular weight (Mₙ) between 5000 g/mol and 50,000 g/mol; and (b) the weight ratio of the olefin prepolymer component to the residual catalyst component is from 5:1 to 600:1.

### Examples

A spray-dried activated catalyst composition is prepared using the procatalyst shown in Formula 2 and methylaluminoxane activator, which are deposited on the surface of a Cabosil-filled particle using the processes described in PCT Publication 2007/058981 A1 (15 Apr. 2017). The activated catalyst composition is formulated as 43 μmol Zr/g with a 158:1 Al-to-Zr molar ratio; the activated catalyst composition comprises 18.5% Al by weight. The activated catalyst composition is prepared by adding methylaluminoxane to a slurry of fumed Cabosil TS-610 in toluene, and then adding the molecular biphenylphenol procatalyst. The mixture is stirred for 30-60 minutes and then spray-dried. The spray dried catalyst particles can be fed directly into the prepolymerization reactor; no further modification is performed as the Zr sites are activated during the preparation of the spray-dried catalyst.

The activated catalyst composition is prepolymerized in a slurry in a 2 L PDC reactor. The reactor is fitted with a 4 blade turbine for efficient mixing. The polymerization is conducted using 750 ml of diluent shown in Table 1. The diluent is added to the reactor at the beginning of the run, along with 20 ml of 1-hexene comonomer and 3.3 liter of hydrogen. Ethylene is fed to the reactor on demand to maintain a total reactor pressure of 325 psi and an ethylene partial pressure of 125 psi and the reactor is heated to the temperature shown in Table 1. When the reactor is at the desired pressure and temperature, 10 mg of catalyst is injected into the reactor, and the reaction allowed to proceed for 10 minutes.

The resulting catalytically-active prepolymer composition is recovered under nitrogen atmosphere and purged with nitrogen to remove residual diluent.

TABLE 1
The prepolymerization is carried out 5 times as shown in Table 1.

| | | | | | Prepolymer |
|---|---|---|---|---|---|
| | | | | | yield, g |
| | | Reaction | Reaction | | prepoly/g |
| Inventive | | Temp, | Time, | | spray- |
| Example | Diluent | ° C. | min | Yield, g | dried catalyst |
| 1 | Isobutane | 55 | 5 | 3.74 | 343.1 |
| 2 | Isopentane | 55 | 5 | 2.05 | 202.9 |
| 3 | Isobutane | 65 | 5 | 4.29 | 437.7 |
| 4 | Isopentane | 65 | 5 | 3.75 | 357.1 |
| 5 | Isobutane | 70 | 5 | 5.29 | 503 |

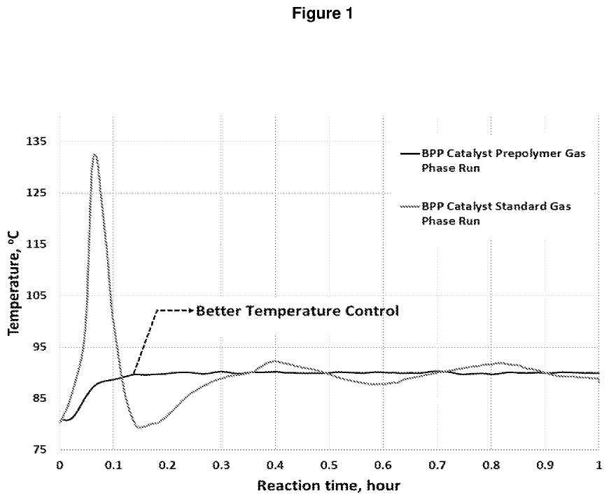

A 2.2 g sample of the catalytically-active prepolymer composition in Example 5 is used to catalyze a gas-phase polymerization of ethylene at 85° C. and 230 psi, yielding 30 g gas phase resin. The reaction is carried out a 2 L PDC reactor equipped with a helical impeller. The reaction is conducted using 400 g salt bed and 3 g of spray dried methyl alumoxane as a passivating agent. Hydrogen and hexene are continuously added to the reactor at an ethylene molar ratio of 0.15 and 0.004. While the reactor pressure is maintained at 300 psi, ethylene partial pressure is maintained at 230 psi. The reaction is semibatch and ethylene is fed on demand to maintain a constant ethylene pressure. The reactor temperature is measured using a Type E thermocouple. The results are shown in FIG. 1.

As a comparison, an attempt is made to use the spray-dried biphenylphenol catalyst to catalyze a gas-phase polymerization under similar conditions without prepolymerization. The polymerization could not be completed because the rapid temperature growth in the reactor caused the reactor to form excessive polymer sheets and chunks. The temperature measured in the reactor is shown in FIG. 1 for comparative purposes.

Test Methods:
The following test methods are used for measurements described in this document:

| Measurement | Test Method |
|---|---|
| Density | ASTM D792-13, Standard Test Methods for Density and Specific |
| | Gravity (Relative Density) of Plastics by Displacement, Method B |
| | (for testing solid plastics in liquids other than water, e.g., in liquid |
| | 2-propanol). QC Density is measured after conditioning 10 to 15 |
| | min and density is measured after conditioning at least 40 hours. |
| Melt Index (“I₂”) | ASTM D1238-13, Standard Test Method for Melt Flow Rates of |
| | Thermoplastics by Extrusion Platometer, using conditions of 190° C./ |
| | 2.16 kg, formerly known as “Condition E”. |
| Molecular Weight | Determined by Gel Permeation Chromatography as described |
| (Mₙ and M_{w}) | below. |
| Quantity of Residual | The quantity of residual catalyst composition in the catalytically- |
| Catalyst in | active prepolymer composition can be determined by measuring |
| Prepolymer | the concentration residual catalytic metal from the biphenylphenol |
| | procatalyst using Inductively Coupled Plasma - Optical Emission |
| | Spectroscopy (ICP -OES). A sample of catalytically-active |
| | prepolymer composition is digested with a strong acid mixture |
| | and analyzed using commercially-available instruments such as a |
| | 4300 DV Optima Spectrometer from Perkin Elmer, Waltham MA. |

### Molecular Weight

Molecular weights, including peak molecular weight (M_{p(GPC)}), weight average molecular weight (M_{w(GPC)}), number average molecular weight (M_{n(GPC)}), and z-average molecular weight (M_{z(GPC)}), are measured using conventional Gel Permeation Chromatography (GPC) and are reported in grams per mole (g/mol).

The chromatographic system is a PolymerChar GPC-IR (Valencia, Spain) high temperature GPC chromatograph equipped with an internal IR5 infra-red detector (IR5). The autosampler oven compartment is set at 160° C. and the column compartment is set at 150° C. The columns used are four Agilent “Mixed A” 30 centimeter (cm) 20-micron linear mixed-bed columns. The chromatographic solvent used is 1,2,4 trichlorobenzene containing 200 parts per million (ppm) of butylated hydroxytoluene (BHT). The solvent source is nitrogen sparged. The injection volume used is 200 microliters (μl) and the flow rate is 1.0 milliliters/minute (ml/min).

Calibration of the columns is performed with at least 20 narrow molecular weight distribution polystyrene standards with molecular weights ranging from 580 to 8,400,000 g/mol. Standards are arranged in 6 “cocktail” mixtures with at least a decade of separation between individual molecular weights. The standards are purchased from Agilent Technologies. The standards are prepared at 0.025 grams in 50 milliliters of solvent for molecular weights equal to or greater than 1,000,000 g/mol, and 0.05 grams in 50 milliliters of solvent for molecular weights less than 1,000,000 g/mol. The standards are dissolved at 80° C. with gentle agitation for 30 minutes. The standard peak molecular weights are converted to ethylene-based polymer molecular weights using Equation 1 (as described in Williams and Ward, J. Polym. Sci., Polym. Let., 6, 621 (1968)):

$$\text{?} = A \times {( \text{?} )}^{B} \qquad Equation 1$$

$$\text{?} \text{indicates text missing or illegible when filed}$$

where M is the molecular weight, A has a value of 0.4315, and B is equal to 1.0.

A fifth-order polynomial is used to fit the respective ethylene-based polymer-equivalent calibration points. (In our examples, a minor adjustment to A (from approximately 0.39 to 0.44) is needed to correct for column resolution and band-broadening effects such that NIST standard NBS 1475 is obtained at a molecular weight of 52,000 g/mol.)

The total plate count of the columns is performed with eicosane (prepared at 0.04 grams in 50 milliliters of TCB and dissolved with gentle agitation for 20 minutes). The plate count (Equation 2) and symmetry (Equation 3) are measured on a 200 microliter injection according to the following equations:

$$Plate Count = 5.54 \times {( \frac{{RV}_{Peak Max}}{Peak Width at half height} )}^{2} \qquad Equation 2$$

where RV is the retention volume in milliliters, peak width is in milliliters, peak max is the maximum height of the peak, and half height is one half of the height of peak max, and

$$Symmetry = \frac{( Rear Peak {RV}_{one tenth height} - {RV}_{Peak Max} )}{( {RV}_{Peak Max} - Front Peak {RV}_{one tenth height} )} \qquad Equation 3$$

where RV is the retention volume in milliliters, peak width is in milliliters, peak max is the maximum height of the peak, one tenth height is one tenth of the height of peak max, rear peak refers to the peak tail at retention volumes later than peak max, and front peak refers to the peak front at retention volumes earlier than peak max. The plate count for the chromatographic system should be greater than 22,000 and symmetry should be between 0.98 and 1.22.

Samples are prepared in a semi-automatic manner with the PolymerChar “Instrument Control” Software, wherein the samples are weight-targeted at 2 milligrams per milliliter (mg/ml), and the solvent, which contained 200 ppm BHT, is added to a pre nitrogen-sparged septa-capped vial, via the PolymerChar high-temperature autosampler. The samples are dissolved under “low speed” shaking for 3 hours at 160° C.

The calculations of M_{n(GPC)}, M_{w(GPC)}, and M_{z(GPC)} are based on GPC results using the internal IR5 detector (measurement channel) of the PolymerChar GPC-IR chromatograph according to Equations 4-7, using PolymerChar GPCOne™ software, the baseline-subtracted IR chromatogram at each equally-spaced data collection point i (IRᵢ) and the ethylene-based polymer equivalent molecular weight obtained from the narrow standard calibration curve for the point i (M_{polyethylene,i} in g/mol) from Equation 1. Subsequently, a GPC molecular weight distribution (GPC-MWD) plot (wt_{GPC}(IgMW)) vs. IgMW plot, where wt_{GPC}(IgMW) is the weight fraction of ethylene-based polymer molecules with a molecular weight of IgMW for the ethylene-based polymer sample can be obtained. Molecular weight (MW) is in g/mol and wt_{GPC}(IgMW) follows the Equation 4.

$$\int {wt}_{GPC} ( lg MW ) dlg MW = 1. \qquad Equation 4$$

M_{n(GPC)}, M_{w(GPC)} and M_{z(GPC)} are calculated by the following equations:

$${Mn}_{( GPC )} = \frac{{\sum }^{i} {IR}_{i}}{{\sum }^{i} ( {IR}_{i} / {M}_{polyethylene {,}_{i}} )} \qquad Equation 5$$

$${Mw}_{( GPC )} = \frac{{\sum }^{i} ( {IR}_{i} * {M}_{polyethylene {,}_{i}} )}{{\sum }^{i} {IR}_{i}} \qquad Equation 6$$

$${Mz}_{( GPC )} = \frac{{\sum }^{i} ( {IR}_{i} * {{M}_{{polyethylene}_{, i}}}^{2} )}{{\sum }^{i} ( {IR}_{i} * {M}_{polyethylene {,}_{i}} )} \qquad Equation 7$$

M_{p(GPC)} is the molecular weight at which the wt_{GPC}(IgMW) had the highest value on the GPC-MWD plot.

In order to monitor the deviations over time, a flow rate marker (decane) is introduced into each sample via a micropump controlled with the PolymerChar GPC-IR system. This flow rate marker (FM) is used to linearly correct the pump flow rate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flow rate (Flowrate (effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flow rate (with respect to the narrow standards calibration) is calculated as Equation 11. Processing of the flow marker peak is done via the PolymerChar GPCOne™ Software. Acceptable flow rate correction is such that the effective flowrate should be within 0.5% of the nominal flowrate.

$$Flow {rate}_{effective} = Flow {rate}_{nominal} \times ( RV ( {FM}_{calibrated} ) / RV ( {FM}_{Sample} ) ) \qquad Equation 8$$

1. A process for making a catalytically-active prepolymer composition in a slurry-phase prepolymerization reaction, comprising contacting:
(a) a catalyst composition comprising a biphenylphenol catalyst made by activating a biphenylphenol procatalyst with an activator; and
(b) one or more olefin monomers,
in a diluent under suitable conditions to polymerize the one or more olefin monomers with a yield of 5 parts to 600 parts of the catalytically-active prepolymer composition per 1 part of the catalyst composition by weight;
wherein the biphenylphenol procatalyst is of Formula I: 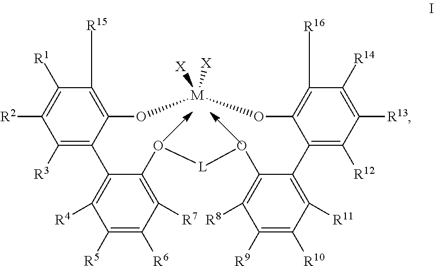
wherein each of R⁷ and R⁸ is independently a C₁ to C₂₀ alkyl, aryl or aralkyl, halogen, or a hydrogen;
wherein each of R⁴ and R¹¹ is independently a hydrogen, alkyl or a halogen;
wherein each of R⁵ and R¹⁰ is independently a C₁ to C₂₀ alkyl, aryl, aralkyl, halogen, an alkyl- or aryl-substituted silyl, or a hydrogen;
wherein each of R² and R¹³ is independently a C₁ to C₂₀ alkyl, aryl or aralkyl or a hydrogen;
wherein each of R¹⁵ and R¹⁶ is independently a 2,7-disubstituted carbazol-9-yl;
wherein each of R¹, R³, R⁶, R⁹, R¹², and R¹⁴ is independently a hydrogen or alkyl;
wherein L is a saturated C₂-C₃ alkylene that forms a 2-carbon bridge or 3-carbon bridge between the two oxygen atoms to which L is bonded;
wherein each X is independently halogen, a hydrogen, a (C₁-C₂₀)alkyl, a (C₇-C₂₀)aralkyl, a (C₁-C₆)alkyl-substituted (C₆-C₁₂)aryl, or a (C₁-C₆)alkyl-substituted benzyl, —CH₂Si(R^{C})₃, where R^{C} is 01-C₁₂ hydrocarbon; and
wherein M is zirconium or hafnium.

2. The process as described in claim 1 wherein the one or more olefin monomers comprise 80 to 100 mole percent ethylene monomer and 0 to 20 mole percent of an α-olefin comonomer that contains from 4 to 8 carbon atoms, based on total quantity of the one or more olefin monomers.

3. The process as described in claim 1 wherein the yield of the catalytically-active prepolymer composition is 5 parts to 400 parts of the catalytically-active prepolymer composition per 1 part of the catalyst composition by weight.

4. The process as described in claim 3 wherein the yield of the catalytically-active prepolymer composition is 5 parts to 200 parts of catalytically-active prepolymer composition per 1 part of the catalyst composition by weight.

5. The process as described in claim 1 wherein the diluent is an alkane that contains from 4 to 10 carbon atoms.

6. The process as described in claim 1 wherein the weight ratio of the diluent to total olefin monomers is from 5:1 to 800:1.

7. The process as described in a claim 1 wherein the suitable conditions comprise a temperature of the slurry-phase prepolymerization reaction from 25° C. to 80° C.

8. The process as described in claim 1 wherein the biphenylphenol procatalyst meets the following formula: 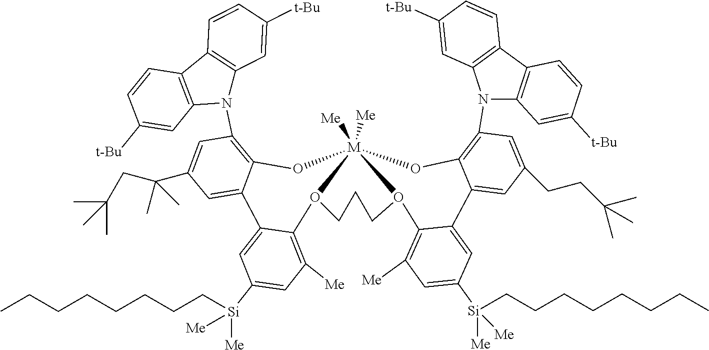
wherein M is a zirconium ion or a hafnium ion, t-Bu refers to a tertiary butyl group, t-Oct refers to a tertiary octyl group, n-Oct refers to a linear octyl group, and Me refers to a methyl group.

9. The process as described in claim 1 wherein the yield of 5 parts to 600 parts of the catalytically-active prepolymer composition per 1 part of the catalyst composition by weight is achieved by controlling the total amount of the one or more olefin monomers used in the contacting step.

10. A process to make a polyolefin (co)polymer, comprising the steps of:
(a) making a catalytically-active prepolymer composition in a slurry-phase prepolymerization reaction as described in claim 1; and
(b) using the catalytically-active prepolymer composition to catalyze gas-phase polymerization of further one or more olefin monomers to make the polyolefin (co)polymer.

11. The process as described in claim 10 wherein the temperature of the slurry-phase prepolymerization reaction is at least 5° C. lower than the temperature of the gas phase polymerization.

12. The process as described in claim 1 wherein the gas phase polymerization step takes place in the presence of a diluent that is the same as the diluent used in the slurry-phase prepolymerization reaction.

13. The process as described in claim 1 (i) wherein the catalytically-active prepolymer composition is fed directly from the slurry-phase prepolymerization step to the fluidized bed polymerization step without recovering and passivating the catalytically-active prepolymer composition; or (ii) wherein the catalytically-active prepolymer composition is recovered after the slurry-phase prepolymerization step, passivated, and stored before being used in the gas-phase polymerization step; or both (i) and (ii).

14. The process as described in claim 1 which comprises the following steps:
(a) making the catalyst composition by depositing the biphenylphenol procatalyst and the activator on a silicon-containing carrier material, wherein the activator contains aluminum and contacts the biphenylphenol procatalyst;
(b) performing the slurry-phase prepolymerization reaction by contacting the catalyst composition with one or more olefin monomers that contain 80 to 100 mole percent ethylene and 0 to 20 mole percent of an α-olefin comonomer having 4 to 8 carbons in an alkane diluent having 3 to 12 carbon atoms, to form a catalytically-active prepolymer composition that contains both an olefin prepolymer component and a residual catalyst component in a weight ratio from 5:1 and 600:1, wherein the olefin prepolymer component consists essentially of one or more olefin prepolymers and wherein the residual catalyst component consists essentially of remnants of the catalyst composition; and
(c) performing a gas-phase fluidized bed polymerization reaction by contacting the catalytically-active prepolymer composition with further one or more olefin monomers that contain 80 to 100 mole percent ethylene and 0 to 20 mole percent of an α-olefin comonomer having 4 to 8 carbons under conditions suitable to make a polyolefin (co)polymer.

15. A catalytically-active prepolymer composition made by claim 1,
the process as described in claim 1,
In some embodiments the catalytically-active prepolymer composition comprises:
(1) an olefin prepolymer component consisting essentially of one or more olefin prepolymers and
(2) a residual catalyst component consisting essentially of remnants of the catalyst composition left over after the prepolymerization reaction; and
wherein: (a) the olefin prepolymer component has a number average molecular weight (Mₙ) between 5000 g/mol and 50,000 g/mol; and (b) the weight ratio of the olefin prepolymer component to the residual catalyst component is from 5:1 to 600:1.
